(19) United States
(12) Patent Application Publication
(10) Pub. No.: US 2019/0104579 A1
(43) Pub. Date: Apr. 4, 2019

(54) LIGHT-EMITTING DIODE DRIVING CIRCUITAND LIGHTING APPARATUS THEREOF

(71) Applicant: GUAN-JIE LUO, Taipei (TW)

(72) Inventor: Shao-Wei Chiu, Taipei (TW)

(73) Assignee: GUAN-JIE LUO, Taipei (TW)

(21) Appl. No.: 16/147,581

(22) Filed: Sep. 29, 2018

(30) Foreign Application Priority Data
Sep. 29, 2017 (TW) 106133715

(51) Int. Cl. H05B 33/08; H01G 9/26

(52) U.S. Cl. CPC H05B 33/0809; H01G 9/26; H05B 33/0845

(57) ABSTRACT

A light-emitting diode lighting apparatus includes a light emitting package structure; a plurality of light-emitting diode (LED) units; a rectifier unit for driving the light-emitting diode (LED) units; a first linear constant current unit electrically coupled with an output end of the light-emitting diode (LED) units; a light-modulating unit electrically coupled with the first linear constant current unit for modulating a current of the first linear constant current unit; a second linear constant current unit electrically coupled with the rectifier unit; and an electrolytic capacitor coupled and cooperated with the second linear constant current unit for providing a buffer for the light-emitting diode (LED) units. The second linear constant current unit and the electrolytic capacitor are both electrically coupled with an input end of the light emitting diode (LED) units.

### CROSS REFERENCE

THE PRESENT INVENTION CLAIMS PRIORITY TO TW106133715, FILED ON Sep. 29, 2017.

### BACKGROUND OF THE INVENTION

### Field of Invention

The present invention relates to a light-emitting diode driving circuit and lighting apparatus thereof. Especially, the present invention relates to a light-emitting diode driving circuit and lighting apparatus thereof, which has a high power factor and no flicker phenomenon, and can perform brightness adjustment.

### Description of Related Art

Currently, in lighting applications where a rectified alternative-current (AC) voltage is used as a driving power source directly, a light-emitting diode (LED) is getting more and more popular in the market. Since the light-emitting diode has many advantages, such as low power consumption, durability and persistence, high efficiency of electric conversion, energy saving, etc. The light-emitting diode is a current driving component, whose lighting brightness or luminance is proportional to the magnitude of the driving current. It is often necessary to use a number of light-emitting diodes connecting with each other in series for providing sufficient light source to achieve superior brightness and uniform brightness requirements. Comparing with a prior incandescent lamp or a prior fluorescent lamp, the light-emitting diode needs light-modulating while maintaining luminous or lighting quality at the same time, which is difficult for a light-emitting diode designer and really different from the incandescent lamp or the fluorescent lamp.

In addition, the light-emitting diode often has a flicker phenomenon, which is a phenomenon in which the intensity and brightness of the light-emitting diode may change with time passes by. The flicker phenomenon influences the lighting quality of the light-emitting diode very much. Whether the flicker phenomenon can be recognized by the human eyes, the flicker will have many bad effects on and be harmful to the human body, such as headache, blurred vision, vertigo, eye fatigue, restlessness, and even epileptic reactions or epilepsy. Due to the characteristics of the light-emitting diode (LED) itself, the flicker phenomenon is more often than other lighting apparatus (such as incandescent lamps, fluorescent lamp, etc.). Especially, when the light-emitting diode lighting apparatus needs to modulate a luminous flux or a light intensity, the flicker phenomenon is much more serious. Therefore, how to eliminate flicker phenomenon, adjust the brightness of the light-emitting diode and keep a high power factor, has become a major problem in the existing light-emitting diode (LED) technology.

### SUMMARY OF THE INVENTION

To the technical problems above-mentioned, the objects of the present invention are to provide a light-emitting diode driving circuit and a lighting apparatus thereof, which delivers a high power factor and no flicker phenomenon, and can perform brightness adjustment. The present light-emitting diode driving circuit and lighting apparatus can eliminate the flicker phenomenon efficiently and perform the brightness adjustment function, and have these advantages of long life and effective energy saving, etc.

The main feature of the present invention is using at least one linear constant current unit for eliminating a ripple current of a light-emitting diode (current ripple free), so that the flicker phenomenon can be eliminated to achieve the flicker-free object.

The present invention provides an electrolytic capacitor as a buffer to achieve an accurate and ripple-free drive current value of light-emitting diode units.

In one perspective, the present invention provides a light-emitting diode driving circuit which can perform a brightness adjustment and eliminate a flicker phenomenon. The light-emitting diode driving circuit comprises a plurality of light-emitting diode units, a rectifier unit, a first linear constant current unit, a light-modulating unit, a second linear constant current unit, an electrolytic capacitor, a first electrode and a second electrode. The second linear constant current unit and the electrolytic capacitor electrically connect with a common node (input end) of the light-emitting diode units, and the first linear constant current units electrically connect with another node (output end) of each string of light-emitting diode units respectively.

In one embodiment, the light-emitting diode units, the rectifier unit, the first linear constant current unit, the light-modulating unit, the second linear constant current unit, and the electrolytic capacitor can be implemented by a semiconductor manufacturing process. The light-emitting diode units, the rectifier unit, the first linear constant current unit, the light-modulating unit, the second linear constant current unit, and the electrolytic capacitor are integrally packaged together, wherein the packaging method includes semiconductor manufacturing processes, stamping processes, or punched package manufacturing processes, etc.

In another perspective, the present invention provides a light-emitting diode lighting apparatus which can perform a brightness adjustment and eliminate a flicker phenomenon. The light-emitting diode lighting apparatus comprises a light emitting package structure, a plurality of light-emitting diode units, a rectifier unit, a first linear constant current unit, a light-modulating unit, a second linear constant current unit, an electrolytic capacitor, a first electrode and a second electrode. The second linear constant current unit and the electrolytic capacitor electrically connect with a common node (input end) of the light-emitting diode units, and the first linear constant current units electrically connect with another node (output end) of each string of light-emitting diode units respectively.

In one embodiment, The light emitting package structure, the light-emitting diode units, the rectifier unit, the first linear constant current unit, the light-modulating unit, the second linear constant current unit, and the electrolytic capacitor are integrally packaged together, wherein the packaging method includes semiconductor manufacturing processes, stamping processes, or punched package manufacturing processes, etc.

For better understanding the above and other aspects of the present invention, the detailed description of the embodiments and the accompanying drawings are provided as follows.

### BRIEF DESCRIPTION OF THE DRAWINGS

FIG. 1 shows a light-emitting diode driving circuit diagram which can perform a brightness adjustment and eliminate a flicker phenomenon according to a first embodiment of the present invention.

FIG. 2 shows a light-emitting diode driving circuit diagram which can perform a brightness adjustment and eliminate a flicker phenomenon according to a second embodiment of the present invention.

FIG. 3 shows a light-emitting diode driving circuit diagram which can perform a brightness adjustment and eliminate a flicker phenomenon according to a third embodiment of the present invention.

FIG. 4 shows a light-emitting diode driving circuit diagram which can perform a brightness adjustment and eliminate a flicker phenomenon according to a fourth embodiment of the present invention.

### DESCRIPTION OF THE PREFERRED EMBODIMENTS

The objectives, technical details, features, and effects of the present invention will be better understood with regard to the further detailed description of the embodiments below, with reference to the drawings. Obviously, the described embodiment is only a part of the present invention, rather than all.

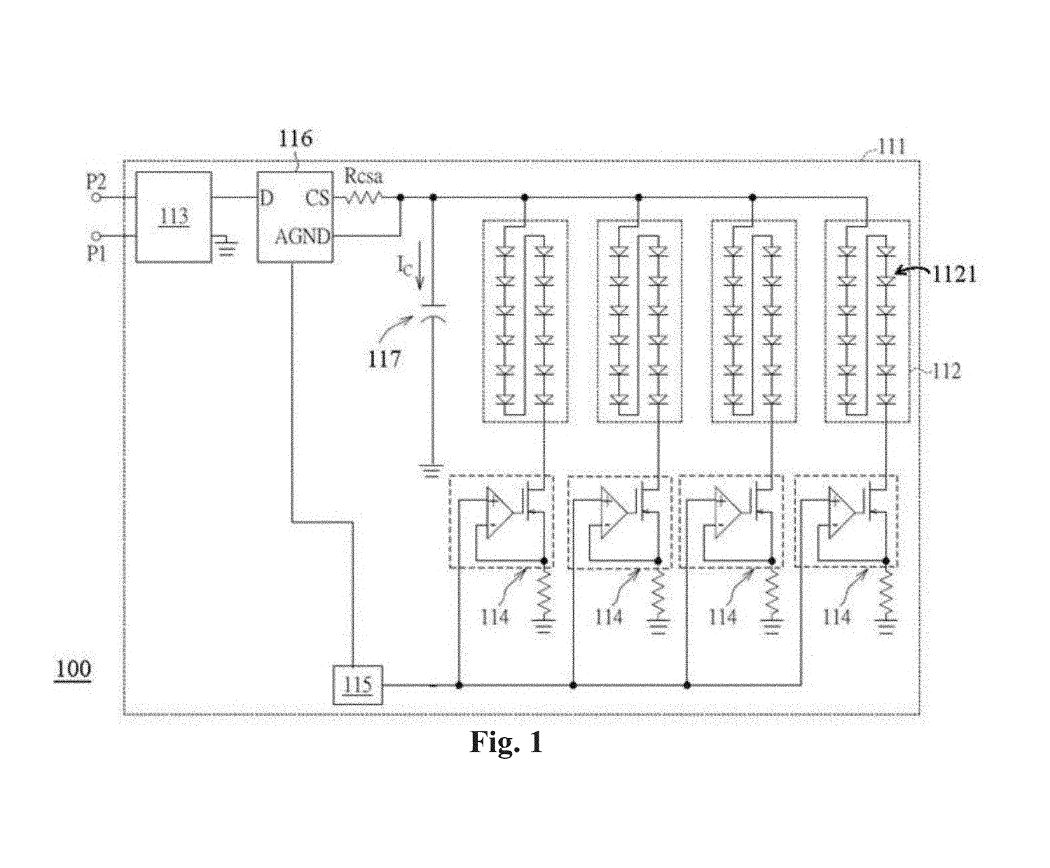

Please refer to FIGS. 1, which shows a light-emitting diode driving circuit diagram which can perform a brightness adjustment and eliminate a flicker phenomenon according to a first embodiment of the present invention. As shown in FIG. 1, a light-emitting diode lighting apparatus 100 comprises a light emitting package structure 111, a plurality of light-emitting diode units 112, a rectifier unit 113, a first linear constant current unit 114, a light-modulating unit 115, a second linear constant current unit 116, an electrolytic capacitor 117, a first electrode P1 and a second electrode P2, wherein the second linear constant current unit 116 and the electrolytic capacitor 117 are electrically connected with a common node (i.e. an input end) of the light-emitting diode units 112, and the first linear constant current unit 114 are electrically connected with another node (i.e. an output node) of each string of the light-emitting diode units 112 respectively. The light emitting package structure 111, the light-emitting diode units 112, the rectifier unit 113, the first linear constant current unit 114, the light-modulating unit 115, the second linear constant current unit 116, and the electrolytic capacitor 117 can be a circuit implemented by a semiconductor manufacturing process. The light emitting package structure 111, the light-emitting diode units 112, the rectifier unit 113, the first linear constant current unit 114, the light-modulating unit 115, the second linear constant current unit 116, and the electrolytic capacitor 117 are integrally packaged together, wherein the packaging method includes semiconductor manufacturing processes, stamping processes, or punched package manufacturing processes, etc. The first electrode P1 and the second electrode P2 of the light emitting package structure 111 are exposed from one end surface of the light emitting package structure 111. The light emitting package structure 111 can be electrically connected with an external power supply (not shown) directly through the first electrode P1 and the second electrode P2.

As shown in FIG. 1, the first embodiment of the present invention shows that the second linear constant current unit 116 is electrically coupled to the rectifier unit 113 and the light-emitting diode units 112, wherein the light-emitting diode units 112 are all electrically connected with the second linear constant current unit 116. One end of each the first linear constant current units 114 is one-on-one electrically coupled to each string of the light-emitting diode units 112 respectively, and the other end of the first linear constant current unit 114 is grounded. Since each string of the light-emitting diode units 112 is coupled to the corresponding linear constant current unit 114, so that each string of the light-emitting diode units 112 can be controlled by the corresponding linear constant current unit 114, respectively. One end of the electrolytic capacitor 117 is coupled to the second linear constant current unit 116, and the other end of the electrolytic capacitor 117 is grounded.

In one embodiment, the present rectifier unit 113 can be a Bridge rectifier. After a full-wave being rectified into a DC (direct-current) sine wave waveform, the light-emitting diode units 112 are then driven.

In one embodiment, the first electrode P1 and the second electrode P2 can be electrically connected with an external power supply (not shown) directly, there is no additional driver set therebetween, so that the volume of the present light-emitting diode lighting apparatus 100 can be largely reduced.

In one embodiment, the light-modulating unit 115 is electrically coupled to the first linear constant current unit 114 and the second linear constant current unit 116. The on-time (i.e. the amount of current) of the first linear constant current unit 114 or the second linear constant current unit 116 is controlled by using a linear level light-modulating signal or a Pulse Width Modulation (PWM) signal. Therefore, the illumination performance of the light-emitting device unit 112, such as light intensity, light brightness or color temperature, can be further controlled by the linear constant current unit 114. The light-modulating unit 115 can be a wireless light-modulating unit 115, and the light emitting package structure 111 can further comprise an energy receiver (not shown) that can wirelessly couple with an external power supply (not shown) to generate a coupling current to provide power to the rectifier unit 113. In this design, the light-emitting diode lighting apparatus 100 can be formed without any power connecting component (not shown), so that the connecting component is omitted. The above-mentioned energy receiver can be implemented by a resonator. In addition, an external controller (not shown) can wirelessly control the wireless light-modulating unit 115. The above-mentioned external controller can be, for example, an electronic device such as a mobile phone or a computer.

In one embodiment, at least part of the light-emit ting diode units 112, at least part of the rectifier unit 113, at least part of the first linear constant current unit 114, at least part of the light-modulating unit 115, at least part of the second linear constant current unit 116, and at least part of the electrolytic capacitor 117 are embedded and packaged in the physical material of the light emitting package structure 111 by using a package technology. Therefore, the above-mentioned components can be in close contact with the light emitting package structure 111 to reduce thermal resistance and improve heat dissipation efficiency. In addition, other prior driving circuit can be embedded and packaged in the physical material of the light emitting package structure 111. The connecting lines between the light-emitting device unit 112, the rectifier unit 113, the first linear constant current unit 114, the wireless light-modulating unit 115, or the second linear constant current unit 116 can be connected before being packaged, or after the packaging process, using printing technology. As a result, the whole outer surface of the light emitting package structure 111 can perform to be a heat dissipation surface, so that the heat generated from the above-mentioned components can be convected into the outer environment through the large outer surface area of the light emitting package structure 111 to accelerate the heat dissipation of the light-emitting diode lighting apparatus 100,

In one embodiment, the above-mentioned package technology can be, for example, a compression molding technology, a liquid encapsulation technology, an injection molding technology, a transfer molding technology, or a punching molding technology.

In one embodiment, the light, emitting package structure 111 is preferred a light transmission structure or a transparent structure, so that the light emitted, by the light-emitting diode units 112 can pass through the light emitting package structure 111 to outside. In addition, the light emitting package structure 111 comprises a fluorescent material for transforming the light wavelength emitting from the light-emitting diode units 112.

In one embodiment, the light-emitting device units 112 may be connected in series or in parallel, or may be connected in both series and parallel. Furthermore, each string of the light-emitting diode units 112 could be a packaged light-emitting diode, which further comprises a fluorescent material for transforming the light wavelength emitting from each light-emitting diode 1121 of the light-emitting diode units 112 respectively. Each string of the light-emitting diode units 112 includes a plurality of light-emitting diode 1121 in series or in parallel, or both in series and in parallel.

In the first embodiment of the present invention, the first linear constant current unit 114 and the second linear constant current unit 116 work together and couple to the light-modulating unit 115 to get an adaptive linear light-emitting diode circuit (adaptive linear current control circuit) with an optimal efficiency. For example, when the brightness is adjusted to full brightness by the light-modulating unit 115, the current flowing through the second linear constant current unit is the maximum current. As the light-modulating signal of the light-modulating unit 115 becomes smaller, the current flowing through the second linear constant current unit 116 is correspondingly reduced, resulting in a small change in overall efficiency.

Furthermore, when the brightness of the light of the light-emitting diode lighting apparatus 100 is to be modulated, dimmed or adjusted to be small, the current of the first linear constant current unit 114 corresponding to the respective group of the light-emitting diode units 112 is accordingly reduced, and the current (total current) flowing through the second linear constant current unit 116 is also reduced. At this time, the current (total current) flowing through the second linear constant current unit 116 only needs to give sufficient energy, so that the current of the second linear constant current unit 116 can be also adjusted to be small. Therefore, the energy is not supplied more than necessary and is consumed by the first linear constant current unit 114 corresponding to other light-emitting diode units 112, so that the power energy can be in balance and not wasted to achieve the effects of eliminating the flicker phenomenon and light-modulating (adjusting brightness) simultaneously.

As mentioned above, the second linear constant current unit 116 is used for limiting the maximum current of the overall light-emitting diode lighting apparatus 100, by providing the current required by each string of light-emitting diode units 112 while supplementing the energy of the electrolytic capacitor 117. When the sine wave input voltage is at the bottom of the valley, the light-emitting diode units 112 cannot provide energy to the circuit load, and the energy of the light-emitting diode units 112 can be provided by the electrolytic capacitor 117, since the energy of the electrolytic capacitor 117 is supplemented. For the current of each string of light-emitting diode units 112, the present invention can achieve both dimmable (brightness adjustable) and flicker-free functions, since the first linear constant current unit 114 can be controlled separately, and the second linear constant current unit 116 and the electrolytic capacitor 117 are used to supplement the required current while performing light-modulating or adjusting brightness.

In the present invention, the electrically connecting relationship of the light-emitting diode units 112, the rectifier unit 113, the first linear constant current unit 114, the light-modulating unit 115, the second linear constant current unit 116 and the electrolytic capacitor 117 are not limited by the first embodiment of the present invention shown in FIG. 1. Other examples for the electrically connecting relationship can be illustrated as follows.

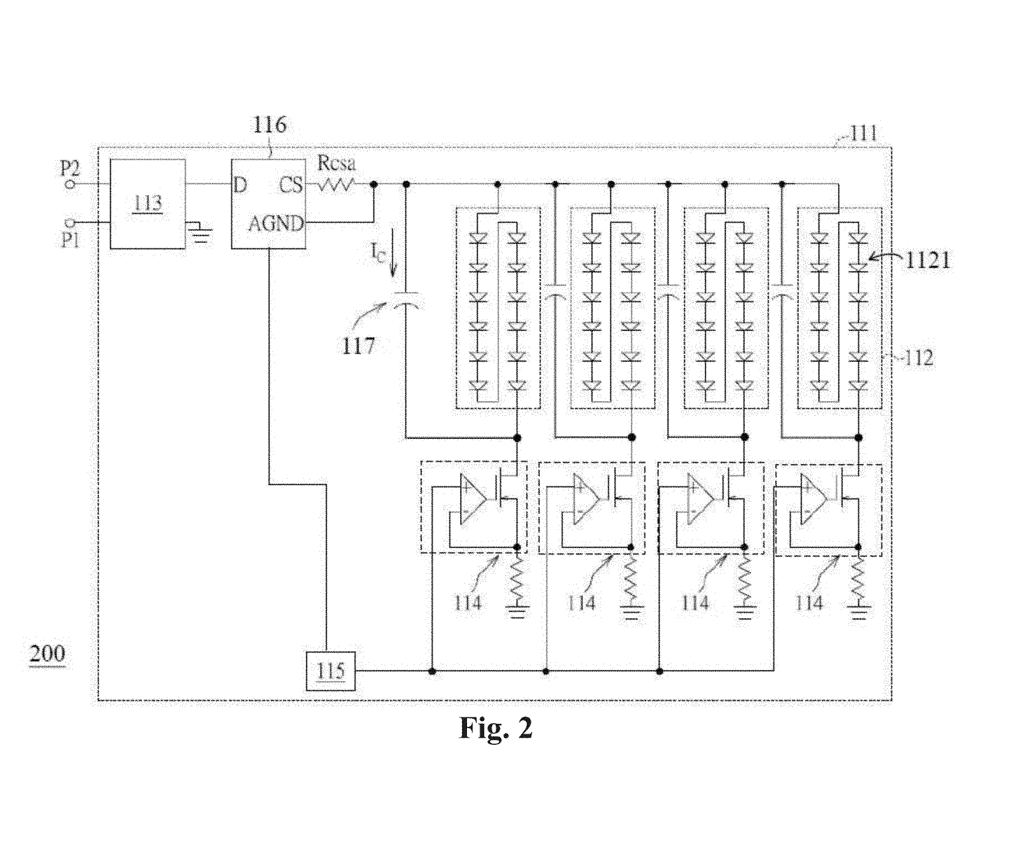

Please refer to FIG. 2, which shows a light-emitting diode driving circuit diagram which can perform a brightness adjustment and eliminate a flicker phenomenon according to a second embodiment of the present invention. As shown in FIG. 2, the light-emitting diode lighting apparatus 200 comprises a light emitting package structure 111, a plurality of light-emitting diode units 112, a rectifier unit 113, a plurality of first linear constant current units 114, a light-modulating unit 115, a second linear constant current unit 116, a plurality of electrolytic capacitors 117, a first electrode P1 and a second electrode P2, wherein the light emitting package structure 111, the light-emitting diode units 112, the rectifier unit 113, the first linear constant current unit 114, the light-modulating unit 115, the second linear constant current unit 116, and the electrolytic capacitors 117 are integrally packaged together. The above-mentioned packaging method includes semiconductor manufacturing processes, stamping processes, or punched package manufacturing processes, etc.

As shown in FIG. 2, the second embodiment of the present invention shows that the second linear constant current unit 116 is electrically coupled to the rectifier unit 113 and the light-emitting diode units 112, wherein the light-emitting diode units 112 are all electrically connected with the second linear constant current unit 116. One end of each the first linear constant current unit 114 is one-on-one electrically coupled to each string of the light-emitting diode units 112 respectively, and the other end of the first linear constant current unit 114 is grounded. Since each string of the light-emitting diode units 112 is coupled to the corresponding linear constant current unit 114, so that each string of the light-emitting diode units 112 can be controlled by the corresponding linear constant current unit 114, respectively. One common end of the electrolytic capacitors 117 is coupled to the second linear constant current unit 116, and the other end of each the electrolytic capacitor 117 connects with two ends of and across the string of the light-emitting diode units 112 respectively in a one-on-one manner, as shown in FIG. 2. The electrolytic capacitor 117 and the light-emitting diode units 112 electrically connect with each other in parallel. The light-modulating unit 115 is coupled to both the first linear constant current unit 114 and the second linear constant current unit 116. The on-time (i.e. the amount of current) of the first linear constant current unit 114 or the second linear constant current unit 116 is controlled by using a linear level light-modulating signal or a Pulse Width Modulation (PWM) signal. The difference between the light-emitting diode lighting apparatus 200 of FIG. 2 and the light-emitting diode lighting apparatus 100 of FIG. 1 is that the light-emitting diode lighting apparatus 200 of FIG. 2 comprises a plurality of (more than one) electrolytic capacitors 117, and each the electrolytic capacitor 117 connects with two ends of and across the string of the light-emitting diode units 112 respectively in a one-on-one manner for providing a buffer to adjust the current of the light-emitting diode units 112 respectively.

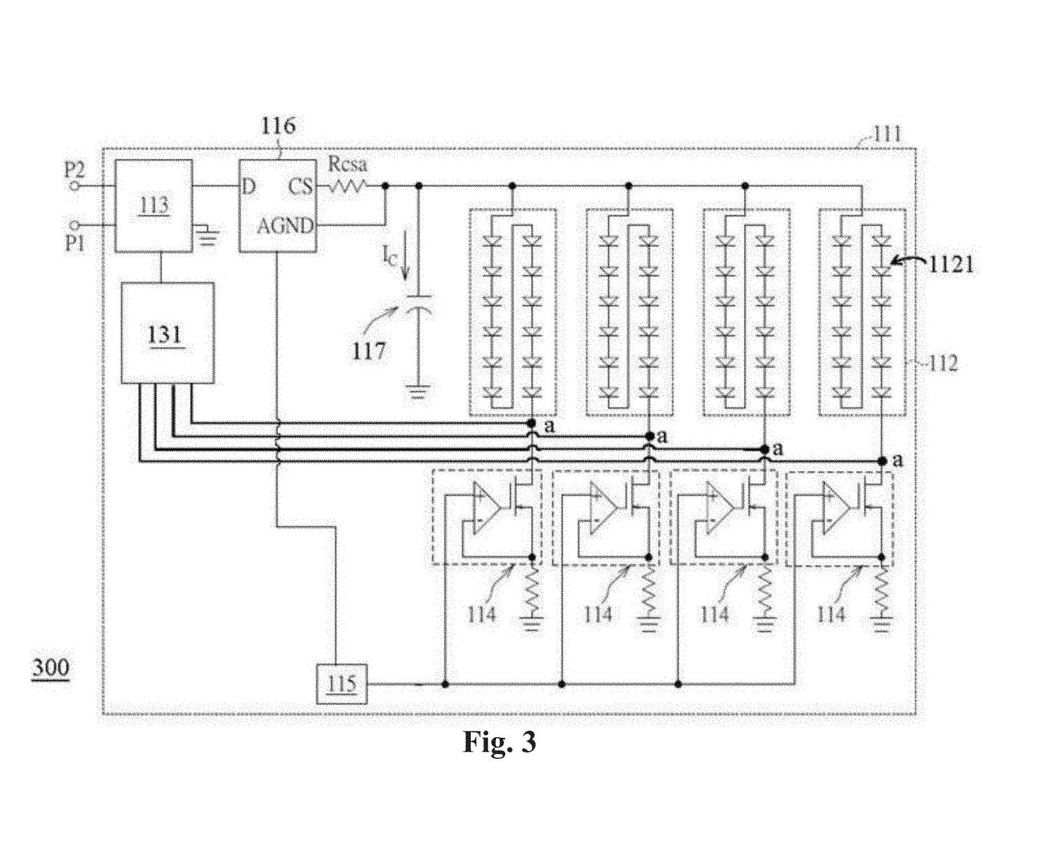

Please refer to FIG. 3, which shows a light-emitting diode driving circuit diagram, which can pier form a brightness adjustment and eliminate a flicker phenomenon according to a third embodiment of the present invention. As shown in FIG. 3, the light-emitting diode lighting apparatus 300 comprises a light emitting package structure 111, a plurality of light-emitting diode units 112, a rectifier unit 113, a plurality of first linear constant current units 114, a light-modulating unit 115, a second linear constant current unit 116, a plurality of electrolytic capacitors 117, a buck-boost controlling unit 131, a first electrode P1 and a second electrode P2, wherein the light emitting package structure 111, the light-emitting diode units 112, the rectifier unit 113, the first linear constant current unit 114, the light-modulating unit 115, the second linear constant current unit 116, the electrolytic capacitors 117, and the buck-boost controlling unit 131 are integrally packaged together. The above-mentioned packaging method includes semiconductor manufacturing processes, stamping processes, or punched package manufacturing processes, etc.

As shown in FIG. 3, the third embodiment of the present invention shows that the second linear constant current unit 116 is electrically coupled to the rectifier unit 113 and the light-emitting diode units 112, wherein the light-emitting diode units 112 are all electrically connected with the second linear constant current unit 116. One end of each the first linear constant current unit 114 is one-on-one electrically coupled to each string of the light-emitting diode units 112 respectively, and the other end of the first linear constant current unit 114 is grounded. Since each string of the light-emitting diode units 112 is coupled to the corresponding linear constant current unit 114, so that each string of the light-emitting diode units 112 can be controlled by the corresponding linear constant current unit 114, respectively. One common end of the electrolytic capacitors 117 is coupled to the second linear constant current unit 116, and the other end of each the electrolytic capacitor 117 is grounded. The light-modulating unit 115 is coupled to both the first linear constant current unit 114 and the second linear constant current unit 116. The on-time (i.e. the amount of current) of the first linear constant current unit 114 or the second linear constant current unit 116 is controlled by using a linear level light-modulating signal or a Pulse Width Modulation (PWM) signal. The difference between the light-emitting diode lighting apparatus 300 of FIG. 3 and the light-emitting diode lighting apparatus 100 of FIG. 1 is that the light-emitting diode lighting apparatus 300 of FIG. 3 can feed back a voltage value at each node a to the buck-boost controlling unit 131 for adjusting the driving voltage of the rectifier unit 113.

In one embodiment, only one of the light-emitting diode units 112 or only part of the light-emitting diode units 112 can be coupled to the buck-boost controlling unit 131. It is not necessarily to couple all of the light-emitting diode units 112 to the buck-boost controlling unit 131, as shown in FIG. 3.

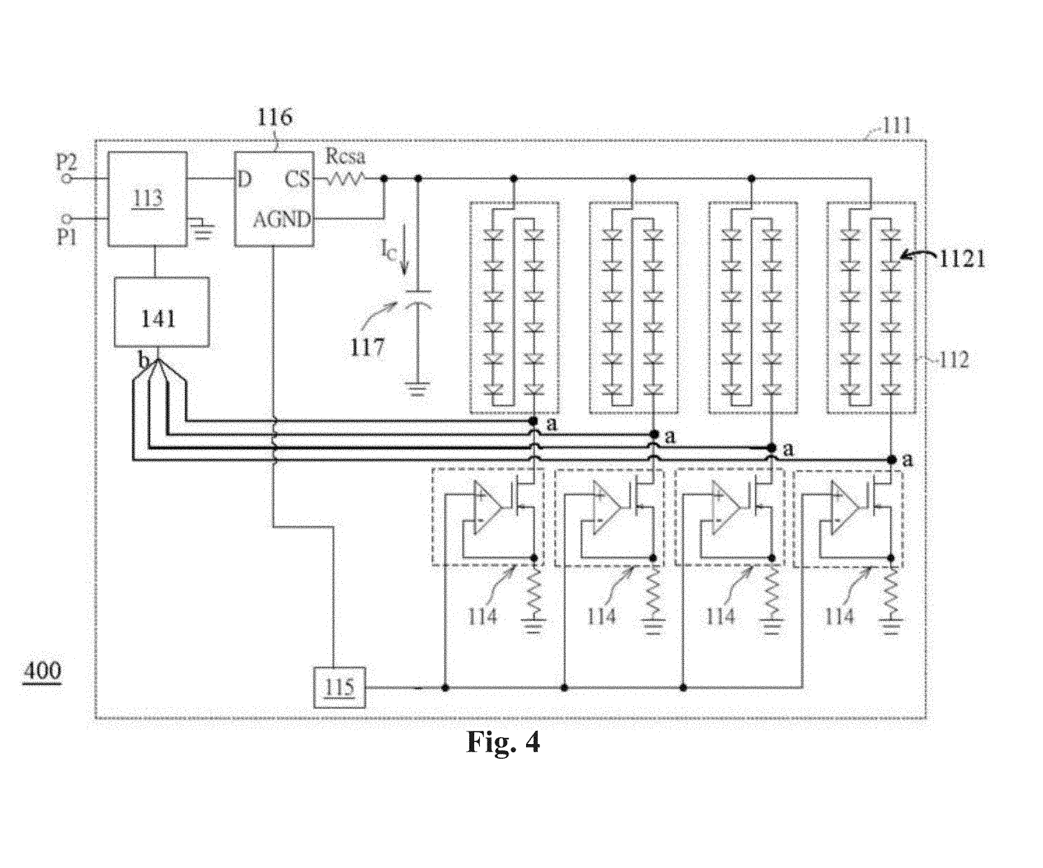

Please refer to FIG. 4, which shews a light-emitting diode driving circuit diagram which can perform a brightness adjustment and eliminate a flicker phenomenon according to a fourth embodiment of the present invention. As shown in FIG. 4, the light-emitting diode lighting apparatus 400 comprises a light emitting package structure 111, a plurality of light-emitting diode units 112, a rectifier unit 113, a plurality of first linear constant current units 114, a light-modulating unit 115, a second linear constant current unit 116, a plurality of electrolytic capacitors 117, a buck-boost controlling unit 141, a first electrode P1 and a second electrode P2, wherein the light emitting package structure 111, the light-emitting diode units 112, the rectifier unit 113, the first linear constant current unit 114, the light-modulating unit 115, the second linear constant current unit 116, the electrolytic capacitors 117, and the buck-boost controlling unit 141 are integrally packaged together. The above-mentioned packaging method includes semiconductor manufacturing processes, stamping processes, or punched package manufacturing processes, etc.

As shown in FIG. 4, the fourth embodiment of the present invention shows that the second linear constant current unit 116 is electrically coupled to the rectifier unit 113 and the light-emitting diode units 112, wherein the light-emitting diode units 112 are all electrically connected with the second linear constant current unit 116. One end of each the first linear constant current unit 114 is one-on-one electrically coupled to each string of the light-emitting diode units 112 respectively, and the other end of the first linear constant current unit 114 is grounded. Since each string of the light-emitting diode units 112 is coupled to the corresponding linear constant current unit 114, so that each string of the light-emitting diode units 112 can be controlled by the corresponding linear constant current unit 114, respectively. One common end of the electrolytic capacitors 117 is coupled to the second linear constant current unit 116, and the other end of each the electrolytic capacitor 117 is grounded. The light-modulating unit 115 is coupled to both the first linear constant current unit 114 and the second linear constant current unit 116. The on-time (i.e. the amount of current) of the first linear constant current unit 114 or the second linear constant current unit 116 is controlled by using a linear level light-modulating signal or a Pulse Width Modulation (PWM) signal. The difference between the light-emitting diode lighting apparatus 400 of FIG. 4 and the light-emitting diode lighting apparatus 300 of FIG. 3 is that the light-emitting diode lighting apparatus 400 of FIG. 4 can feed back the voltage value at each node a to a common node b of the buck-boost controlling unit 141 for adjusting the driving voltage of rectifier unit 113.

The present invention provides at least one or more than one linear constant current unit (114,116) to achieve an accurate and ripple-free (i.e. no flicker) drive current value which the light-emitting diode units 112 need. If there are many string of light-emitting diode units 112 connecting in series, the current of each string of light-emitting diode units 112 can be controlled independently. The problem of unstable or uneven current due to the opening of certain path of the light-emitting diode units 112 can be eliminated.

In the above-mentioned embodiments, the location of the second linear constant current unit 116 is not limitted on the common input node of the light-emitting diode units 112. The location of the second linear constant current, unit 116 can be also set on a common output node of the light-emitting diode units 112, or can be set on one of the output path of the light-emitting diode units 112 (not shown), as long as the purpose of the present invention can be achieved.

In one embodiment, the light-modulating method of the present invention comprises: a linear level light-modulating method, which can use a silicon controlled rectifier to adjust the conduction angle of the input alternate-current; or a Pulse Width Modulation (PWM) method, wherein a high frequency pulse is provided by adjusting the pulse duty cycle of the lamp driving voltage, or using a lower frequency pulse to modulate the high frequency pulse.

It should be noted that the diagrams of the light-emitting diode lighting apparatus (100, 200, 300, 400) of the above-mentioned embodiments shown in FIGS. 1˜4 are merely examples, and the packaging method and the driving circuit of the present invention are not limited to the light-emitting diode lighting apparatus (100, 200, 300, 400) shown in FIGS. 1˜4. It can also be applied to any type light-emitting diode device (not shown), which can improve the heat dissipation efficiency of the light-emitting device, stabilize the flow of the light-emitting device, maintain stable illumination quality, free flicker (flicker) phenomenon, and achieve actively light-modulating (brightness adjusting).

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention.

What is claimed is:

1. A light-emitting diode (LED) driving circuit comprising:
a plurality of light-emitting diode units;
a rectifier unit for providing power to the light-emitting diode units;
a first linear constant current unit electrically connecting with an output node of the light-emitting diode units for controlling each of the light-emitting diode units;
a second linear constant current unit electrically connecting with the rectifier unit and an input node of the light-emitting diode units for controlling each of the light-emitting diode units;
a light-modulating unit electrically connecting with the first linear constant current unit and the second linear constant current unit for adjusting the current of the light-emitting diode units; and
an electrolytic capacitor electrically connecting with the second linear constant current unit;
wherein the second linear constant current unit and electrolytic capacitor electrically connect with the input node of the light-emitting diode units;
wherein, the second linear constant current unit is used for limiting a maximum current of the light-emitting diode (LED) driving circuit, providing the current required by the light-emitting diode units, and supplementing an energy to the electrolytic capacitor.

2. The light-emitting diode driving circuit of claim 1, wherein the light-emitting diode units, the rectifier unit, the first linear constant current unit, the light-modulating unit, the second linear constant current unit, and the electrolytic capacitor are integrally packaged together.

3. The light-emitting diode driving circuit of claim 1, further comprising a plurality of electrolytic capacitors and a plurality of strings of light-emitting diode units, one common end of the plurality of electrolytic capacitors electrically connecting with the second linear constant current unit, while the other end of each the electrolytic capacitor connecting with two ends of each the string of the light-emitting diode units respectively and across the string of the light-emitting diode units in a one-on-one mariner, for providing a buffer to adjust the current of the light-emitting diode units respectively.

4. The light-emitting diode driving circuit of claim 1, further comprising a buck-boost controlling unit electrically connecting with the rectifier unit, for feeding back a voltage value at the output node of the light-emitting diode units respectively to the buck-boost controlling unit for adjusting a driving voltage of the rectifier unit.

5. The light-emitting diode driving circuit of claim 1, further comprising a buck-boost controlling unit electrically connecting with the rectifier unit, for feeding back a voltage value at a common node coupled to all the output nodes of the light-emitting diode units to the buck-boost controlling unit for adjusting a driving voltage of the rectifier unit.

6. The light-emitting diode driving circuit of claim 1, wherein an on-time of the first linear constant current unit is controlled by the light-modulating unit through a linear level light-modulating signal or a Pulse Width Modulation (PWM) signal, wherein each of the light-emitting diode units emits light according to the linear level light-modulating signal or the Pulse Width Modulation (PWM) signal.

7. A light-emitting diode lighting apparatus comprising:
a light emitting package structure;
a plurality of light-emitting diode units embedded and packaged in the light emitting package structure;
a rectifier unit embedded and packaged in the light emitting package structure for providing power to the light-emitting diode units;
a first linear constant current unit embedded and packaged in the light emitting package structure, and electrically connecting with an output node of the light-emitting diode units for stabilizing the light-emitting diode units;
a second linear constant current unit embedded and packaged in the light emitting package structure, and electrically connecting with the rectifier unit and an input node of the light-emitting diode units for stabilizing the light-emitting diode units;
a light-modulating unit embedded and packaged in the light emitting package structure, and electrically connecting with the first linear constant current unit and the second linear constant current unit for adjusting the current of the light-emitting diode units; and
an electrolytic capacitor embedded and packaged in the light emitting package structure, and electrically connecting with the second linear constant current unit;
wherein the second linear constant current unit and electrolytic capacitor electrically connect with the input node of the light-emitting diode units;
wherein the second linear constant current unit is used for limiting a maximum current of the light-emitting diode (LED) driving circuit, providing the current required by the light-emitting diode units, and supplementing an energy to the electrolytic capacitor.

8. The light-emitting diode lighting apparatus of claim 7, wherein the light-emitting diode units, the rectifier unit, the first linear constant current unit, the light-modulating unit, the second linear constant current unit, and the electrolytic capacitor are integrally packaged together.

9. The light-emitting diode lighting apparatus of claim 7, further comprising a plurality of electrolytic capacitors and a plurality of strings of light-emitting diode units, one common end of the plurality of electrolytic capacitors electrically connecting with the second linear constant current unit, while the other end of each the electrolytic capacitor connecting with two ends of each the string of the light-emitting diode units respectively and across the string of the light-emitting diode units in a one-on-one manner, for providing a buffer to adjust the current of the light-emitting diode units respectively.

10. The light-emitting diode lighting apparatus of claim 7, further comprising a buck-boost controlling unit, wherein at least part of the buck-boost controlling unit is embedded and packaged in the light emitting package structure, and the buck-boost controlling unit electrically connects with the rectifier unit, for feeding back a voltage value at the output node of the light-emitting diode units respectively to the buck-boost controlling unit for adjusting a driving voltage of the rectifier unit.

11. The light-emitting diode lighting apparatus of claim 7, further comprising a buck-boost controlling unit, wherein at least part of the buck-boost controlling unit is embedded and packaged in the light emitting package structure, and the buck-boost controlling unit electrically connects with the rectifier unit, for feeding back a voltage value at a common node coupled to all the output nodes of the light-emitting diode units to the buck-boost controlling unit for adjusting a driving voltage of the rectifier unit.
